(19) United States
(12) Patent Application Publication
(10) Pub. No.: US 2016/0358498 A1
(43) Pub. Date: Dec. 8, 2016

(54) Method for Training Crew in a Flight Simulator

(71) Applicant: The Boeing Company, Chicago, IL (US)

(72) Inventors: Lars Fucke, Madrid (ES); Bruno Correia Gracio, Madrid (ES)

(73) Assignee: The Boeing Company, Chicago, IL (US)

(21) Appl. No.: 15/137,008

(22) Filed: Apr. 25, 2016

(30) Foreign Application Priority Data
Jun. 8, 2015 (EP) 15382299.4

(51) Int. Cl. G09B 9/16; G09B 9/20; G09B 9/18

(52) U.S. Cl. CPC G09B 9/16; G09B 9/18; G09B 9/20; G09B 9/206; G09B 9/203

(57) ABSTRACT

A method for training flight crew in a flight simulator that comprises opening a database of flight events, wherein each flight event has desired flight crew performance (DFCP) data that comprise user data associated with expected user actions; generating a training session by selecting at least one flight event from the database of flight events; running the training session in the flight simulator with at least one student; gathering student data based on student actions during the training session; and comparing the gathered student data to the DFCP data corresponding to the same at least one flight event to produce a comparison result. The obtained comparison result allows establishing whether required flight competencies associated with the generated training session have been reached by the student.

### RELATED PATENT APPLICATION

This application claims the benefit of foreign priority from European Patent Application No. EP15382299.4 filed on Jun. 8, 2015.

### BACKGROUND

The present disclosure is related to a method for training a flight crew in a flight simulator. More specifically, it describes a highly objective flight-crew training and evaluation method that uses a database wherein previously developed flight events and user performance standards have been stored to compare the stored information with gathered data from actions and performances of a current student or student crew during training of specific flight events. The specific flight events will be associated to specific competencies or skills to be trained.

Flight crew performance evaluation in training is mostly performed subjectively by the flight instructors who are in the flight simulator cabin behind the flight crew being trained.

The flight crews are expected to adopt different strategies in response to different conditions and situations within each phase of flight. Each strategy calls for specific patterns, actions and behaviors when facing specific situations during execution of the training session. In order to evaluate the flight crew performance, the flight instructor observes the flight crew and their performance during training from behind so that the instructor's observations are limited to a subset of manual actions of the flight crew which are visible to the instructor as well as the crew's verbal communications. Besides, since most of the evaluation process relies on subjective interpretation as well as observations being subject to human error and direction of attention by the instructor at that moment, flight crew evaluation can be rather inconsistent and dependent on instructor pedigree and experience.

Because of these uncertainties, instructors face an elevated workload when striving to evaluate the flight crew actions, behaviors and performances, which may degrade the effectiveness of training and evaluating intervention through untimely and inaccurate guidance. Also, during the simulator session in existing solutions, flight instructors would have to be tracking all flight-crew control behavior visually and annotating it. This process is prone to human error due to the high workload of the flight instructor.

Previous solutions required the flight instructor to rely mostly on his/her own operational knowledge to create a flight-training scenario to train/test specific flight-crew skills or competencies. This makes the quality of the flight training very dependent on the quality of the flight instructor.

Furthermore, the number of available instructors for training flight crew is usually quite limited, so it would be desirable to find a solution that attempts to reduce the on-the-job training time of the flight instructors and that allows an improvement in the one-to-one instructor/student ratio.

### SUMMARY

To achieve the advantages and avoid the drawbacks listed above, a method for training flight crew in a flight simulator is disclosed herein. The method of the present disclosure provides a significant improvement over existing solutions since it provides a consistent, objective and standardized method for training and evaluating flight crew performance by summarizing all elements of flight crew performance in accordance with objective performance requirements. The present method has been specially designed for automatic training and performance evaluation of flight crew actions in a flight simulator. Physical presence of an instructor in the flight simulator cabin may be avoided. The automated training and performance evaluation based on these requirements allows for an immediate and objective summary of flight crew performance during a simulator training session, as well as, in combination with a database of flight events (or scenario components), for automatic branching of a training session. This ensures comprehensive training of the full set of desired flight crew skills or competencies.

In one embodiment, the method for training flight crew in a flight simulator comprises the following steps: opening a database of flight events, each flight event having desired flight crew performance (DFCP) data that, in turn, comprises user data associated with expected user actions; generating a training session by selecting at least one flight event from the database of flight events; running the training session in a flight simulator with at least one student; gathering student data based on student actions and performance during the execution of the training session in the flight simulator; and comparing the gathered student data to the DFCP data corresponding to the same at least one flight event to produce a comparison result.

The flight events database may also store previously developed training sessions, flight performance standards and previous user performance. The training session may be previously and manually generated by an instructor or may be automatically generated by a processor of the flight simulator, when a set of training parameters are provided. Depending on the training parameters provided to the flight simulator, the flight events are selected accordingly. These training sessions may be also stored in the database of flight events for future use. The training session is executed by the flight simulator processor. The comparison step may be performed by the flight simulator processor or by an external device such an iPad, or similar device, if the student actions are checked off manually by the instructor.

Advantageously, the training session can be generated by selecting and combining at least two flight events, although a plurality of flight events might be combined in order to generate a training session.

Advantageously, the DFCP data of the flight events are associated with specific flight competencies or skills. Therefore, specific competencies are associated with specific DFCP data, which in turn are associated to specific flight events. Thus, the flight events are selected depending on the competencies for which the student is to be trained.

The training sessions may be previously and manually generated by the instructor or automatically generated by the flight simulator when a set of training parameters are provided. The training parameters may be the list of skills or competencies to be trained.

Advantageously, the gathered student data are stored in the database of flight events. The stored student data are also associated with the student actions and performance and with the selected flight events and the generated training session. The stored student data might be used to update previously stored flight performance standards or user performance data. Advantageously, the method further comprises generating a report based on the comparison result. This report is automatically generated by the flight simulator or by an external computer device, so the instructor can evaluate the skills of the flight crew. Advantageously, the gathered student data and the DFCP data comprise data from at least one of aircraft handling data, crew action data, verbal communication data, and eye gaze data of a flight crew member. Advantageously, the training session may further comprise at least one flight event of normal or non-normal operations. Advantageously, the method further comprises generating a quantitative proficiency profile based on one or more comparison results. The generation of the quantitative proficiency profile may comprise evaluating the obtained comparison results in order to establish whether the required level of competencies associated with the flight events of the generated training session has been reached by the student. Advantageously and based on this quantitative proficiency profile, the method may generate a list of training deficiencies, and may generate a new training session comprising at least a flight event from the database of flight events to address those training deficiencies. Otherwise, the method may adapt the current training session by modifying some of its parameters in order to address the aforementioned training deficiencies.

In accordance with another embodiment, a computer is programmed to implement the method previously described. In accordance with another embodiment, a computer program is provided that, when executed on a computer, causes the computer to implement the method previously described. In accordance with a further embodiment, the aforementioned computer program is stored in a non-transitory tangible computer-readable storage medium. In accordance with yet another embodiment, a flight simulator is provided that comprises the previously described computer.

One aspect of the subject matter disclosed in detail below is a method for training flight crew in a flight simulator, the method comprising: opening a database of flight events, each flight event having desired flight crew performance data that comprise user data associated with expected user actions; generating a training session by selecting at least one flight event from the database of flight events; running the training session in the flight simulator with at least one student; gathering student data based on student actions during the training session; and comparing the gathered student data to the desired flight crew performance data corresponding to the same at least one flight event to produce a comparison result.

Another aspect is a system comprising: a flight simulator; a database of flight events, each flight event in the database having desired flight crew performance data that comprise user data associated with expected user actions; and a computer configured to execute the following operations: running a training session in the flight simulator, the training session comprising at least one flight event from the database; gathering student data based on student actions during the training session; and comparing the gathered student data to the desired flight crew performance data corresponding to the same at least one flight event to produce a comparison result.

A further aspect is a method for training flight crew in a flight simulator, the method comprising: running a training session in the flight simulator, the training session comprising at least one flight event from a database of flight events, each flight event in the database having desired flight crew performance data that comprise user data associated with expected user actions; gathering student data based on student actions during the training session; comparing the gathered student data to the desired flight crew performance data corresponding to the same at least one flight event to produce a comparison result; and evaluating the results of the comparing operation in order to determine whether the required flight competencies associated with the flight events of the training session have been attained by the user or not. This method may further comprise identifying a training deficiency based on the evaluation of the results of the comparing operation and/or generating a training session comprising at least a flight event from the database of flight events to address training deficiencies.

Other aspects of systems and methods for training flight crew in a flight simulator are disclosed below.

### BRIEF DESCRIPTION OF THE DRAWINGS

FIG. 1 is a flow diagram showing a particular embodiment of the method described in the present specification.

FIG. 2 is a detailed diagram showing information stored in a database of flight events.

FIG. 3 is a detailed flow diagram showing a particular part of the method shown in FIG. 1.

FIG. 4 is a diagram showing a static training session in which primary student skills are trained.

FIG. 5 is a diagram showing a dynamic training session in which primary student skills are trained.

Reference will hereinafter be made to the drawings in which similar elements in different drawings bear the same reference numerals.

### DETAILED DESCRIPTION

Next, a description of several examples of particular embodiments will be provided for the purpose of illustration and without any intention to limit the scope of the claims appended hereto to specific features of those particular embodiments.

In a particular example, the method proposed in the present disclosure comprises a consistent, objective and standardized training and evaluation method of pilot performance in flight crew training by summarizing all elements of pilot performance in accordance with objective performance requirements. The automated evaluation with respect to these requirements allows for immediate and objective summary of pilot performance during a training session in a flight simulator as well as, in combination with a database of flight events, for automatic branching of a flight scenario. This ensures comprehensive training of the full set of desired flight crew skills or competencies.

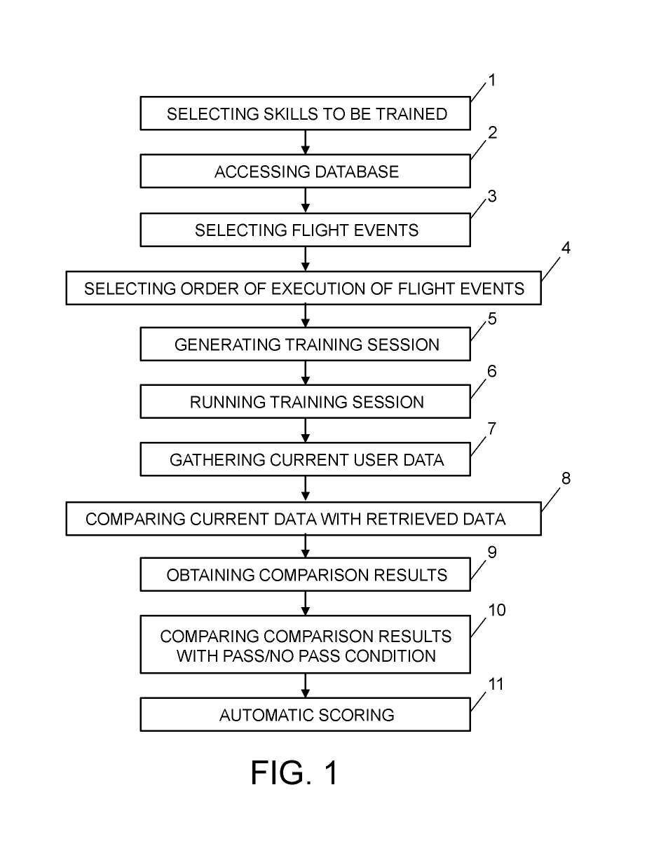

FIG. 1 shows a flow diagram of a particular embodiment of the method for training flight crew in a flight simulator, for the particular case in which the student is an aircraft pilot.

Firstly, and once the aircraft pilot skills (from a list of pilot competencies/skills commonly used for pilot evaluation) to be trained have been selected (step 1), the database of flight events or scenario components is accessed (step 2) and the flight events which correspond with the flight crew competencies to be trained are selected (step 3). The order in which the flight events must be run by the flight simulator is also selected (step 4). This database of flight events and flight crew competencies for different flight phases may be accessed by flight instructors in order to manually design flight-training sessions. The flight simulator may also automatically design a training session by providing the flight simulator with the flight crew competencies to be trained.

Then, the training session or training scenario is generated (step 5) according to the selected flight events or scenario components (step 3) and their execution order (step 4). The training session is run (step 6) by the student pilot or flight crew in the flight simulator without the physical presence of the instructor. During the execution of the training session (step 6), the flight simulator gathers data according to the student actions and performance (step 7). Specifically, the flight simulator gathers data corresponding to handling information, student actions, verbal communications, and eye gaze, although other data might be gathered, such as video recording, etc. Then these data are compared (step 8) with the DFCP data stored in the database of flight events in order to obtain comparison results (step 9) that will reflect the competencies of the student pilot.

The student pilot can then be evaluated objectively, and to a large degree automatically, based on the DFCP metrics stored within the database. In order to pass each one of the DFCPs associated to the selected flight events, the pilot must perform the expected actions described in those DFCPs. Each flight event comprises at least one DFCP item, and each DFCP has at least one competency to be trained associated to it. Since DFCPs are related to flight competencies, passing the DFCP means that the student is proficient in the specific competencies associated to that DFCP.

Based on a pass/no pass condition stored within the flight event, which is compared against the obtained comparison results (step 10), the flight crew is automatically scored (step 11) against the entirety of skills trained during simulation of the flight event. In a particular embodiment, when several skills are to be evaluated simultaneously, the method may return a score for each one of the evaluated skills. The obtained score is then the number of DFCPs that were passed (for a certain flight event or the whole training session) by the pilot. At the end of the training session, these scores are summarized and associated to the respective skills/competencies. A quantitative proficiency profile for the flight crew is presented to the flight instructor which allows for immediate re-focusing of the training or a pass/no-pass decision. This database structure allows for two different functionalities: (1) design of flight-training scenarios or sessions; and (2) evaluation of flight crews during execution of the flight-training scenario or session.

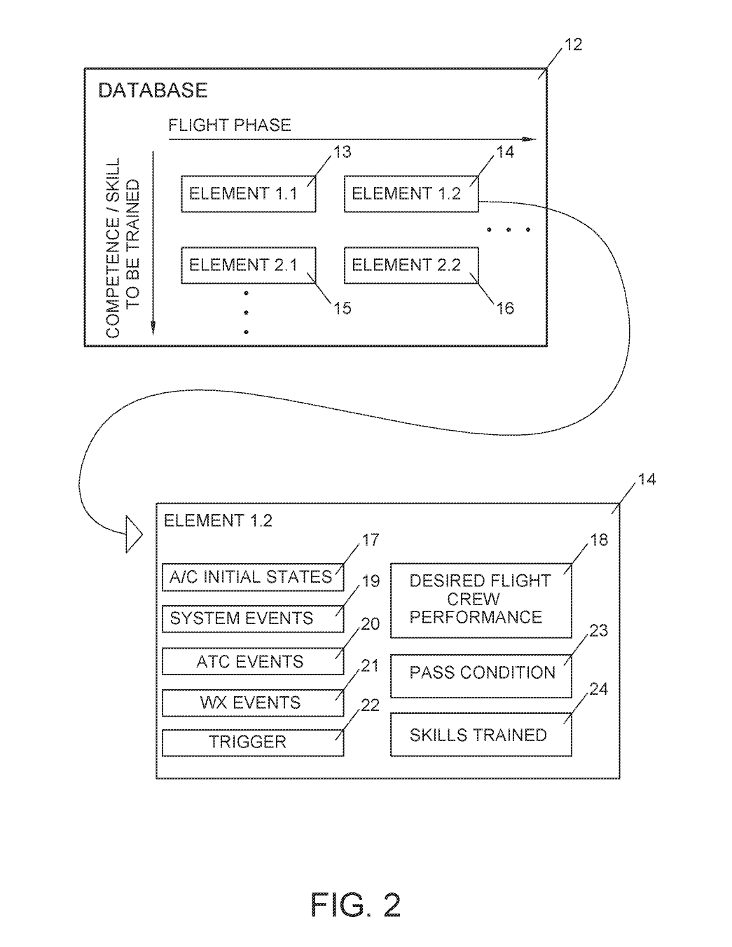

During the generation of a training session, the flight instructor or the flight simulator processor may select only one flight event or either may select and combine several flight events for generating a training session. Specifically, FIG. 2 shows a particular embodiment in which only one flight event is selected from the database 12 of flight events. The selected flight event is the database element 14 (named “Element 1.2”) which corresponds with the flight event of “train communication during take-off”. Other database elements 13, 15 and 16 that may be also selected are, for example: manual flying during approach, decision-making in emergency descent, etc. The database element 14 further comprises additional training information such as the aircraft initial state 17, the element trigger 22 (for example, a lightning strike could trigger a computer failure), air traffic control (ATC) events 20, weather (WX) conditions 21 (for example, a thunderstorm in the approach path), system events 19 (for example, a system failure such as an engine failure, etc.) associated with the training session and a pass condition 23 (these are the actions that need to be performed to pass the DFCP, e.g., landing within a certain distance from the threshold, applying a thrust reversal within a certain time after touch-down, performing a landing checklist before landing, etc.). The database also stores the extra competencies or skills 24 that this element (flight event) is training (e.g., during a go-around, pilots would train different skills such as decision making and application of procedures). The pass condition 23, for example, might be a threshold such that if the comparison result is over the threshold, it is considered that the pilot has the corresponding skills or competencies. Each flight event stores a set of expected flight crew actions and behaviors, together called desirable flight crew performance data 18. The actions performed during the execution of a training session by the student pilot must comply, at least partially, with the DFCP associated with the corresponding training scenarios to successfully go through each training session.

Based on the database 12 of flight events, the instructor may design a training session. The elements of the database 12 may also be training sessions (including one or more flight events) previously designed and stored in the database 12 of flight events.

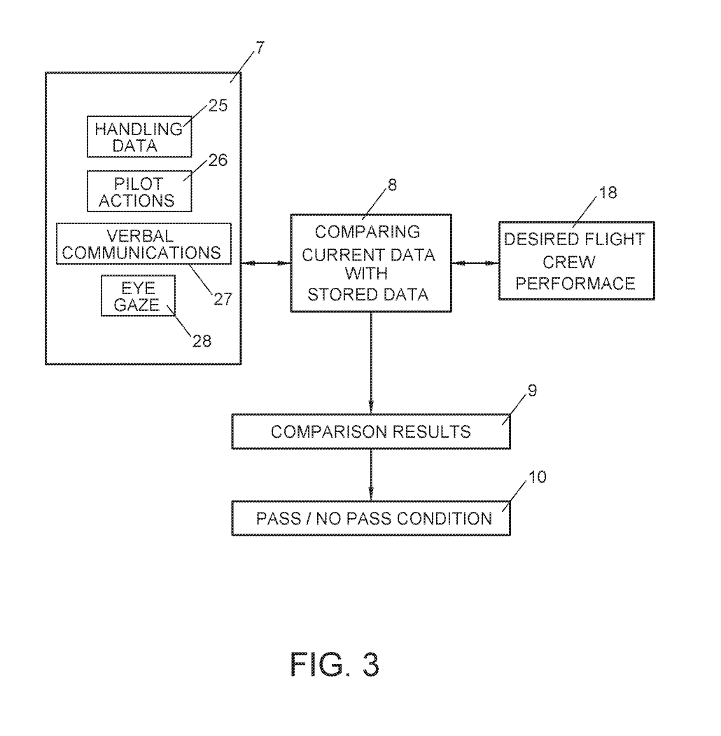

As mentioned before, during the execution of the training session (step 6), the flight simulator gathers data (step 7) according to the student actions and performance. As shown in FIG. 3, this gathered data corresponds to at least handling information 25, pilot action data 26, pilot verbal communication data 27, and pilot eye gaze data 28. Then these data are compared (step 8) with the DFCP data 18 stored in the database 12 in order to obtain comparison results (step 9) that will reflect the competencies of the pilot for establishing whether the obtained results comply with the pass/no pass condition (step 10).

During the training session design phase, instructors or a computer application may retrieve stored user data indicating a user's training deficiencies from the database and use that information to choose the flight events and elements that a flight crew should respond to during the flight phases of the training scenario. Based on the element selection, the tool shows the necessary DFCPs to successfully pass the scenario and show proficiency in a certain skill.

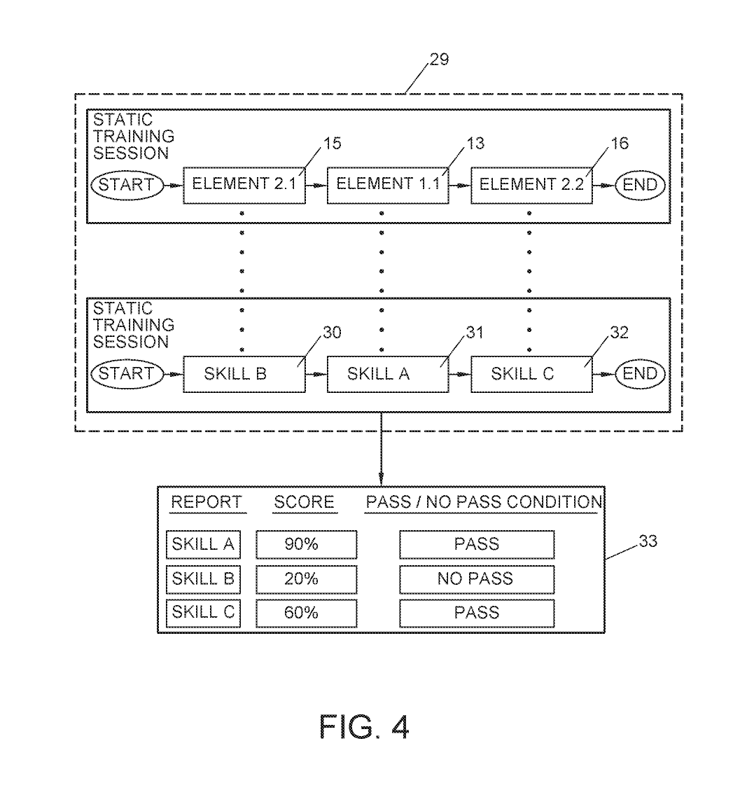

As shown in FIG. 4, a static training session 25 may be designed, where the elements (flight events) of the database are executed in a chronological order. For this static training session, the method automatically shows possible or required follow-up elements. In this particular example, the database element 15 (named “Element 2.1”) describes the flight event of “Raw-data Instrument Landing System approach” that has been designed for training a pilot skill B: “manual flying” (which is evaluated in step 30); the database element 13 (named “Element 1.1”) describes the flight event of “Decision-making in emergency descent” that has been designed for training a pilot skill A: “decision-making under stress conditions” (which is evaluated in step 31); and the database element 16 (named “Element 2.2”) describes the flight event of “Detection of wind turning on tail during approach” that has been designed for training a pilot skill C: “situation awareness” (which is evaluated in step 32).

At the end of the method, the corresponding summarized scores for each one of the trained skills are returned in a report 33. For this particular example, the scores returned are 90% of competence for skill A, 20% of competence for skill B, and 60% of competence for skill C. If a threshold of 50% of competence is previously established for any competence as a pass/no pass condition, it is derivable that the pilot has shown sufficiently high performance for skills A and C but skill B needs to be trained. Then, the method may automatically generate a list of training deficiencies which would include skill B, for this particular case, and automatically generate a new training session comprising flight events to address these training deficiencies. Otherwise, the method may adapt the current training session by modifying some of its parameters in order to address the aforementioned training deficiencies.

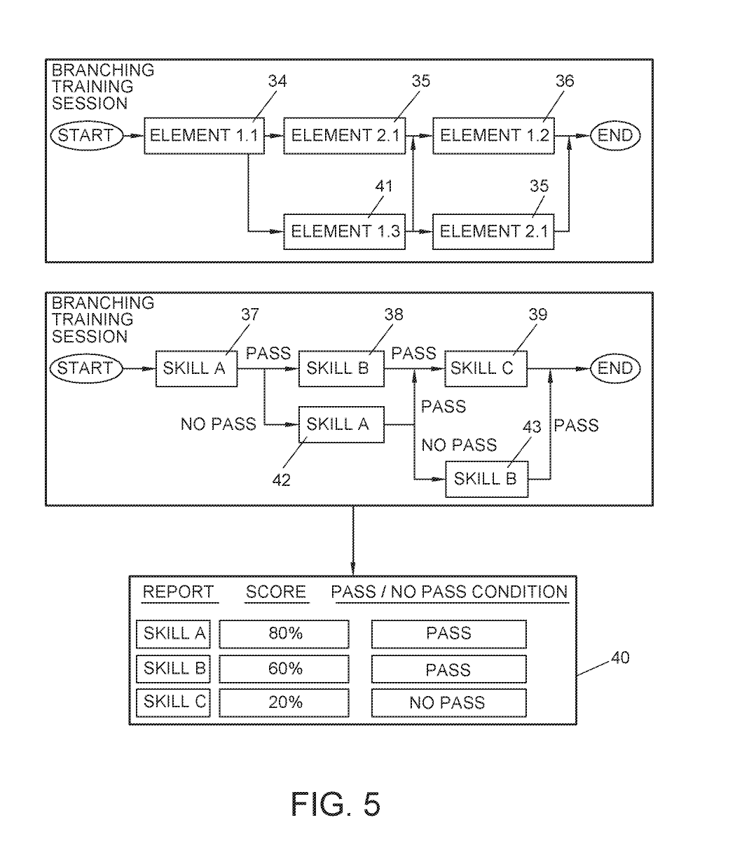

As shown in FIG. 5, a branching scenario session may also be designed where, based on the flight crew performance, the scenario can dynamically follow different paths, creating a more personalized training. For this branching scenario session, the method automatically shows possible or required follow-up elements. In this particular example, the database element 34 (named “Element 1.1”) defines the flight event of “engine failure” that has been designed for training skill A: “decision-making under stress conditions”, which is evaluated in step 37. If the pilot, when faced with database element 34, decides to turn back to the departure airport, then the pass condition is reached and the database element 35 (named “Element 2.1”) is executed. The data element 35 defines the flight event of “electrical failure” that has been designed for training skill B: “Decision-making in emergency descent”, which is evaluated in step 38. The execution of data element 35 would force the pilot to search for a closer airport for landing. Then, if the pilot decides to land at a closer airport, the pass condition is reached and the database element 36 (named “Element 1.2”) is executed and then skill C is evaluated in step 39. The database element 36 defines the flight event of “emergency landing” that has been designed for training skill C: “manual flight in emergency landing”.

On the contrary, if after execution of database element 34, the pilot decides to not turn back to the departure airport and to continue to the destination airport, the pass condition is not reached (i.e., “no pass”) and skill A is then reevaluated in step 42 of the method by executing the database element 41 (named “Element 1.3”) that is associated to a different flight phase but which has also been designed for training skill A. If the pilot then satisfies the pass condition of database element 41, then the method establishes that there is no need for executing database element 35 (so it will appear as not tested in the report 40) and skill C is automatically evaluated in step 39 during execution of database element 36. On the contrary, if the pilot does not satisfy the pass condition of database element 41, then database element 35 (named “Element 2.1”) is executed and then skill B is evaluated in step 43.

At the end of the method, the corresponding summarized scores for each one of the trained skills are returned in a report 40. For a particular case in which database element 34 is failed and database elements 41 and 36 are passed, the scores returned may be 60% for skill A, skill B would appear as not tested, and 90% for skill C (not shown in FIG. 5).

In the example case shown in FIG. 5, the pilot passed database elements 34 and 35 and failed database element 36, and the corresponding scores appearing in report 40 are 80% for skill A, 60% for skill B, and 20% for skill C. If a threshold of 50% of competence has been previously established for any competence as a pass/no pass condition, it is derivable that the pilot has shown sufficiently high performance for skills A and B, but skill C needs to be re-trained. Then, the method may automatically generate a list of training deficiencies which would include skill C for this particular case, and automatically generate a new training session comprising flight events to address those training deficiencies. Otherwise, the method may adapt the current training session by modifying some of its parameters in order to address the aforementioned training deficiencies. Other skills included in the training session but not evaluated by the method (due to the branch selected by the pilot during execution of the training session) might appear in the report 40 labeled as not tested“. Such not tested” skills will be included in the list of training deficiencies.

During the training session execution phase, the database is used to aid the flight instructor in evaluating the flight crew. Some DFCP items can be automatically rated by the flight simulator processor while others might need an action from the flight instructor. During the training session, the tool shows the skills that a flight crew passed/needs to pass in order to complete the training. This helps the flight instructor to get a comprehensive picture of the status of the current training session and of the flight crew's strong and weak points

The methods disclosed herein allow for immediate, objective assessment of the trained flight crew. If done on a training element-by-training element basis, it allows for dynamic branching of the training scenario to ensure that all skills are covered with sufficient depth to determine a quantitative proficiency profile for the trained flight crew.

The methods proposed herein gather most required information in real-time and report the final evaluation to the instructor, allowing him to focus on more critical flight-crew behavior while having a clear overview of the scenario status and flight-crew performance.

Training success evaluation would be significantly more consistent and could be performed by less experienced personnel as the list of DFCP metrics would be approved by manufacturers and regulators prior to training.

Further, embodiments of the methods disclosed may include a computer programmed to operate in accordance with the methods described herein. The computer may be associated with a conventional flight simulator. In turn, the computer may include a processor and a non-transitory tangible computer-readable storage medium for a computer program, that when executed causes the processor to operate in accordance with the methods described herein. The computer program may also be embodied in a transitory tangible computer-readable storage medium having stored therein the computer program.

The advantages of the present disclosure over the solutions disclosed in the state of the art are the following:

(1) The method disclosed herein enables automatic capture of behaviors and performance of a training subject (student) in a flight simulator, and then objectively measures the captured behaviors and performance against the corresponding DFCP data, in order to establish if the DFCP test has been passed and therefore to establish if the training subject has reached specific competencies. The DFCP data will correspond with the flight events of the executed training session. Prior behaviors and performance of the training subjects might also be stored in the database. Furthermore, the method automatically generates appropriate training sessions to address existing proficiency gaps.

(2) The present method reduces and could eliminate the need for a flight instructor/evaluator to be physically present in the flight simulator cabin.

(3) Since the physical presence of a flight instructor during the training phase is not required, the method may allow a single instructor to evaluate a much larger group of students using a consistent and objective set of metrics.

The description of the different advantageous implementations has been presented for purposes of illustration and description, and is not intended to be exhaustive or limited to the implementations in the form disclosed. Many modifications and variations will be apparent to those of ordinary skill in the art. Furthermore, different implementations may provide different advantages as compared to other implementations. Other examples are intended to be within the scope of the claims if they have structural elements that do not differ from the literal language of the claims, or if they include functionally equivalent structural elements with unsubstantial differences from the literal language of the claims.

1. A method for training flight crew in a flight simulator, the method comprising:
opening a database of flight events, each flight event having desired flight crew performance data that comprise user data associated with expected user actions;
generating a training session by selecting at least one flight event from the database of flight events;
running the training session in the flight simulator with at least one student;
gathering student data based on student actions during the training session; and
comparing the gathered student data to the desired flight crew performance data corresponding to the same at least one flight event to produce a comparison result.

2. The method as recited in claim 1, wherein the training session is generated by selecting and combining at least two flight events.

3. The method as recited in claim 2, wherein the desired flight crew performance data of the at least two flight events are associated to respective specific flight competencies and the flight events are selected depending on the flight competencies of the student to be trained.

4. The method as recited in claim 1, wherein the desired flight crew performance data of the at least one flight event is associated to a specific flight competency.

5. The method as recited in claim 1, wherein the gathered student data are stored in the database of flight events, said gathered student data being associated to the student actions and the selected flight events.

6. The method as recited in claim 1, further comprising generating a report based on a result of said comparing operation.

7. The method as recited in claim 1, wherein the gathered student data and the flight crew performance data comprise data from at least one of aircraft handling data, crew action data, verbal communication data, and eye gaze data of a flight crew member.

8. The method as recited in claim 4, further comprising generating a quantitative proficiency profile based on one or more results of said comparing operation.

9. The method as recited in claim 8, wherein said generating a quantitative proficiency profile comprises evaluating the results of said comparing operation in order to determine whether the required flight competencies associated with the flight events of the generated training session have been attained by the user or not.

10. The method as recited in claim 9, further comprising identifying a training deficiency based on the quantitative proficiency profile.

11. The method as recited in claim 9, further comprising generating a training session comprising at least a flight event from the database of flight events to address training deficiencies.

12. The method as recited in claim 9, further comprising adapting the current training session to address training deficiencies.

13. A system comprising:
a flight simulator;
a database of flight events, each flight event in the database having desired flight crew performance data that comprise user data associated with expected user actions; and
a computer configured to execute the following operations:
running a training session in the flight simulator, said training session comprising at least one flight event from the database;
gathering student data based on student actions during the training session; and
comparing the gathered student data to the desired flight crew performance data corresponding to the same at least one flight event to produce a comparison result.

14. The system as recited in claim 13, wherein the training session comprises at least two flight events, the desired flight crew performance data of the at least two flight events are associated to respective specific flight competencies, and the flight events are selected depending on the flight competencies of the student to be trained.

15. The system as recited in claim 13, wherein the computer is further configured to generate a report based on a result of said comparing operation.

16. The system as recited in claim 13, wherein the gathered student data and the flight crew performance data comprise data from at least one of aircraft handling data, crew action data, verbal communication data, and eye gaze data of a flight crew member.

17. The system as recited in claim 14, wherein the computer is further configured to evaluate the results of said comparing operation in order to determine whether the required flight competencies associated with the flight events of the training session have been attained by the user or not.

18. The system as recited in claim 13, wherein the computer is further configured to identify a training deficiency based on said evaluation of the results of said comparing operation.

19. The system as recited in claim 13, wherein the computer is further configured to generate a training session comprising at least a flight event from the database of flight events to address training deficiencies.

20. The system as recited in claim 13, wherein the computer is further configured to adapt the current training session to address training deficiencies.

21. A method for training flight crew in a flight simulator, the method comprising:
running a training session in the flight simulator, said training session comprising at least one flight event from a database of flight events, each flight event in the database having desired flight crew performance data that comprise user data associated with expected user actions;
gathering student data based on student actions during the training session;
comparing the gathered student data to the desired flight crew performance data corresponding to the same at least one flight event to produce a comparison result; and
evaluating the results of said comparing operation in order to determine whether required flight competencies associated with the flight events of the training session have been attained by the user or not.

22. The method as recited in claim 21, further comprising identifying a training deficiency based on said evaluation of the results of said comparing operation.

23. The method as recited in claim 21, further comprising generating a training session comprising at least a flight event from the database of flight events to address training deficiencies.
